(19) United States
(12) Patent Application Publication
(10) Pub. No.: US 2007/0113712 A1
(43) Pub. Date: May 24, 2007

(54) Ratchet wrench with clamping and blocking functions

(76) Inventor: Hsien-Chung Tuan Mu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/281,429

(22) Filed: Nov. 18, 2005

(51) Int. Cl. B25B 13/46

(52) U.S. Cl. 81/63.2

(57) ABSTRACT

A ratchet wrench with clamping and blocking functions includes a shank having an enlarged head formed on one end thereof. A through hole is defined in the enlarged head and a ratchet wheel is pivotally received in the through hole. A first annular groove is defined in an inner periphery of the through hole. The ratchet wheel has a polygonal hole longitudinally defined therein. The polygonal hole extends through the ratchet wheel. A second annular groove and a second annular groove are respectively defined in an inner periphery of the polygonal hole. A stopper is partially received in the second annular groove and adapted to prevent a tool bit overly extending through the ratchet wheel and a retainer is partially received in the third annular groove and adapted to position the tool bit in the ratchet wheel.

### BACKGROUND OF THE INVENTION

1. Field of the Invention

The present invention relates to a ratchet wrench, and more particularly to a ratchet wrench that has clamping and blocking functions.

2. Description of Related Art

A conventional wrench in accordance with the prior art shown in FIGS. 14 and 15 comprises a shank (A) having an enlarged head (B) formed on one end thereof. A polygonal hole (C) is defined in the enlarged head (B) for partially receiving a tool bit (D). One side of the enlarged head (B) is punched to inward form a lip (E) on each side of the polygonal hole (C). The top of tool bit (D) is engaged to the lips (E) to prevent the tool bit (D) from overly extending through the polygonal hole (C) and detached from the enlarged head (B). However, the punch process may transform the shape of the enlarged head (B) and change the standard of the polygonal hole (C). Consequently, the transformed wrenches are wasted.

A second conventional wrench in accordance with the prior art shown in FIGS. 16 and 17 comprises a shank (a) having an enlarged head (b) formed on one end thereof. A polygonal hole (c) is defined in the enlarged head (b) and extends through the enlarged head (b). An annular groove (d) is defined in an inner periphery of the polygonal hole (c) for receiving a clamp element (e) to position the tool bit (f) during operating. However, this embodiment provides no structure to prevent the tool bit (f) form overly extending through the enlarged hole (c). It is an inconvenient design.

The present invention has arisen to mitigate and/or obviate the disadvantages of the two conventional wrenches.

### SUMMARY OF THE INVENTION

The main objective of the present invention is to provide an improved ratchet wrench that has clamping and blocking functions.

To achieve the objective, the ratchet wrench in accordance with the present invention comprises a shank having an enlarged head formed on one end thereof. A through hole is defined in the enlarged head and a ratchet wheel is pivotally received in the through hole. A first annular groove is defined in an inner periphery of the through hole. The ratchet wheel has a polygonal hole longitudinally defined therein. The polygonal hole extends through the ratchet wheel. A second annular groove and a second annular groove are respectively defined in an inner periphery of the polygonal hole. A stopper is partially received in the second annular groove and adapted to prevent a tool bit overly extending through the ratchet wheel and a retainer is partially received in the third annular groove and adapted to position the tool bit in the ratchet wheel.

Further benefits and advantages of the present invention will become apparent after a careful reading of the detailed description with appropriate reference to the accompanying drawings.

### BRIEF DESCRIPTION OF THE DRAWINGS

FIG. 1 is a schematic perspective view of a ratchet wrench with clamping and blocking functions in accordance with the present invention;

FIG. 2 is an exploded perspective view of the ratchet wrench in FIG. 1;

FIG. 3 is a cross-sectional view of the ratchet wrench in FIG. 1;

FIG. 4 is an exploded perspective view of a second embodiment of the ratchet wrench in accordance with the present invention;

FIG. 5 is a cross-sectional view of the second embodiment of the ratchet wrench of the present invention;

FIG. 6 is an exploded perspective view of a third embodiment of the ratchet wrench in accordance with the present invention;

FIG. 7 is a cross-sectional view of the third embodiment of the ratchet wrench of the present invention;

FIG. 8 is an exploded perspective view of a fourth embodiment of the ratchet wrench in accordance with the present invention;

FIG. 9 is a cross-sectional view of the fourth embodiment of the ratchet wrench of the present invention;

FIG. 10 is an exploded perspective view of a fifth embodiment of the ratchet wrench in accordance with the present invention;

FIG. 11 is a cross-sectional view of the fifth embodiment of the ratchet wrench of the present invention;

FIG. 12 is an operational view of the ratchet wrench in accordance with the present invention;

FIG. 13 is an operational view of the ratchet wrench in accordance with the present invention when the tool bit is detached from the ratchet wheel;

FIG. 14 is a partially exploded perspective view of a conventional wrench in accordance with the prior art;

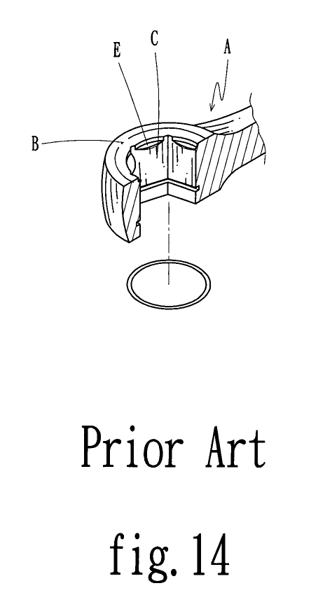

FIG. 15 is a schematic view of the wrench in FIG. 14;

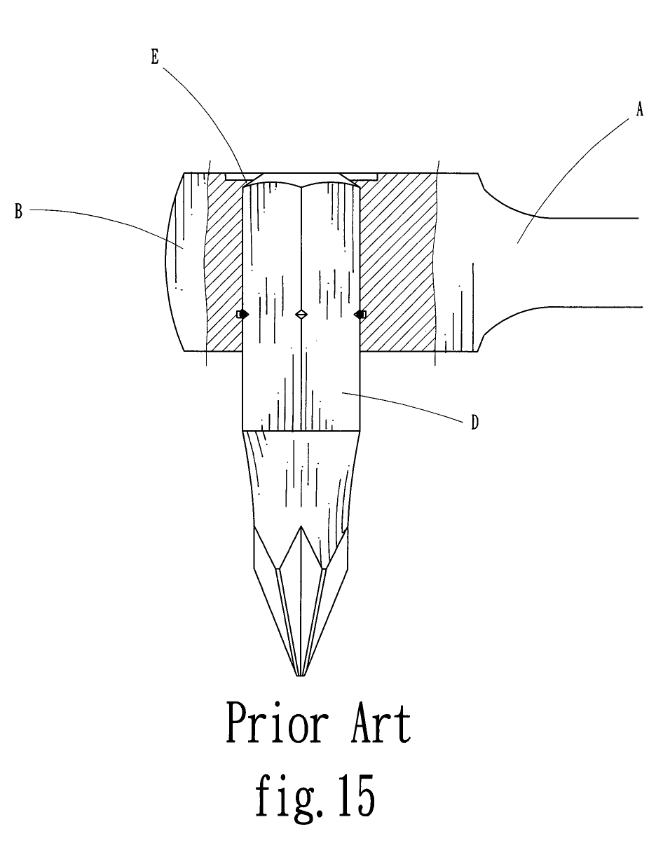

FIG. 16 is a partially exploded perspective view of a second conventional wrench in accordance with the prior art; and

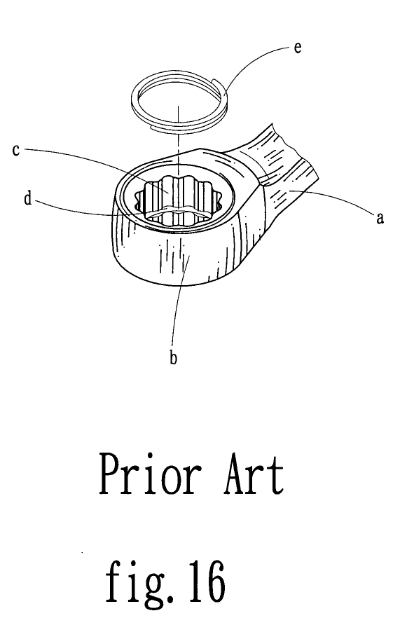

FIG. 17 is a schematic view of the wrench in FIG. 16;

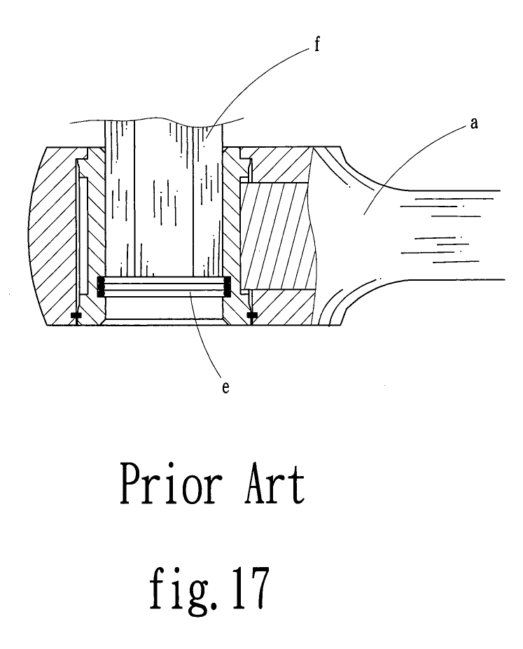

### DETAILED DESCRIPTION OF THE INVENTION

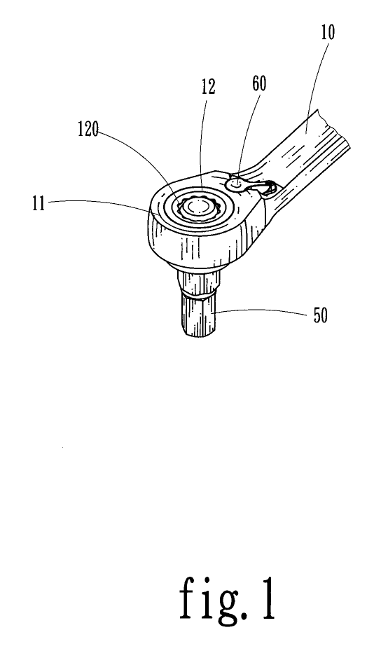

Referring to the drawings and initially to FIGS. 1-4, a ratchet wrench in accordance with the present invention comprises a shank (10) having an enlarged head (11) formed on one end thereof. A through hole (100) is defined in the enlarged head (11). A cavity (101) is defined in the enlarged head (11) and laterally communicates with the through hole (100). A first annular groove (110) is defined in an inner periphery of the through hole (100). A ratchet wheel (12) is pivotally received in the through hole (100) and has a polygonal hole (120) longitudinally defined in the ratchet wheel (12). The polygonal hole (120) extends through the ratchet wheel (12). A second annular groove (121) is defined in an inner periphery of the polygonal hole (120) near a top of the ratchet wheel (12) and a third annular groove (122) is defined in an inner periphery of the polygonal hole (120) near a bottom of the ratchet wheel (12). A fourth annular groove (123) is defined in an outer periphery of the ratchet wheel (12) near the top of the ratchet wheel (12).

A ring-shaped stopper (20) is partially received in the second annular groove (121) in the ratchet wheel (12).

A retainer (30) is partially received in the third annular groove (122). The retainer (30) partially and inward extends into the polygonal hole (120) in the ratchet wheel (12).

A C-shaped ring (40) is mounted between the enlarged head (11) and the ratchet wheel (12) to prevent the ratchet wheel (12) from detaching from the enlarged head (11).

A first tool bit (50) is inserted into the polygonal hole (120) and positioned in the ratchet wheel (12). The first tool bit (50) has an annular groove (51) defined in an outer periphery thereof. The annular groove (51) laterally corresponds to the third annular groove (122) when the first tool bit (50) is inserted into the polygonal hole (12).

A pawl (90) is movably received in the cavity (101) and selectively engaged to the ratchet wheel (12) for deciding the operating direction of the ratchet wheel (12).

A direction control unit (60) is mounted in the enlarged head (11) for driving the pawl (90) to engage to the ratchet wheel (12).

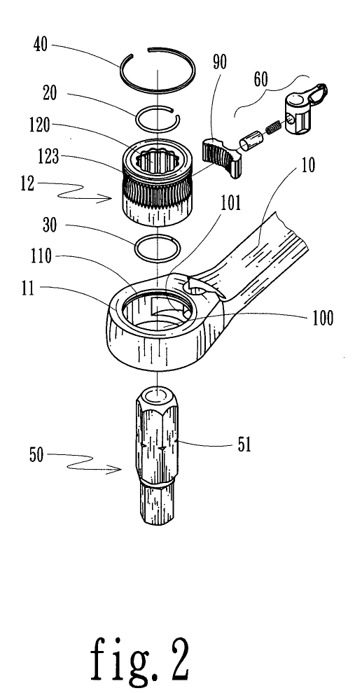

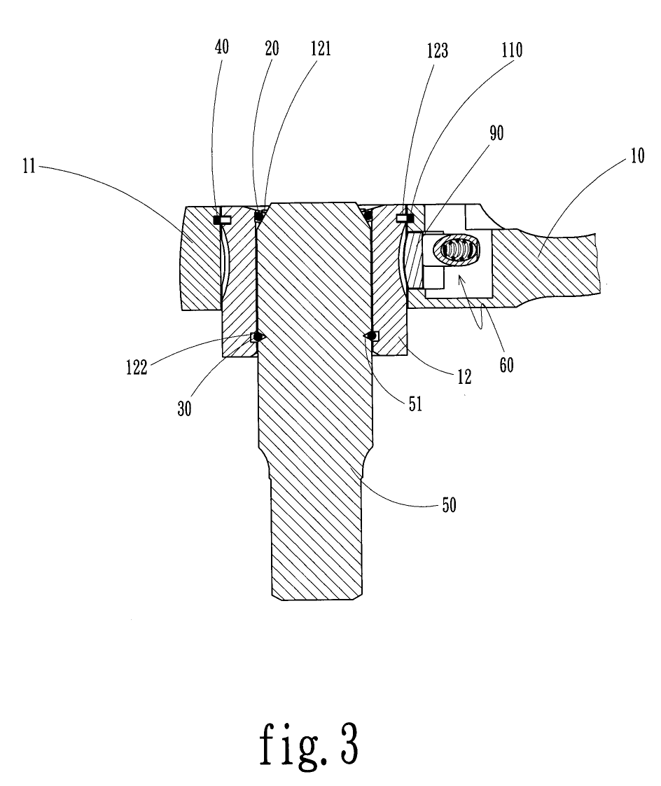

With reference to FIGS. 2 and 3, the C-shaped ring (40) is simultaneously received in the first annular groove (110) in the enlarged head (11) and the fourth annular groove (123) in the ratchet wheel (12) to hold the ratchet wheel (12) in place in the enlarged head (11). The retainer (30) is simultaneously received in the annular groove (51) in the first tool bit (50) and the third annular groove (122) to position the first tool bit (50), and a top of the first tool bit (50) is engaged to the stopper (20) to prevent the first tool bit (50) from overly extending through the ratchet wheel (12) when the first tool bit (50) is inserted into the polygonal hole (120) in the ratchet wheel (12).

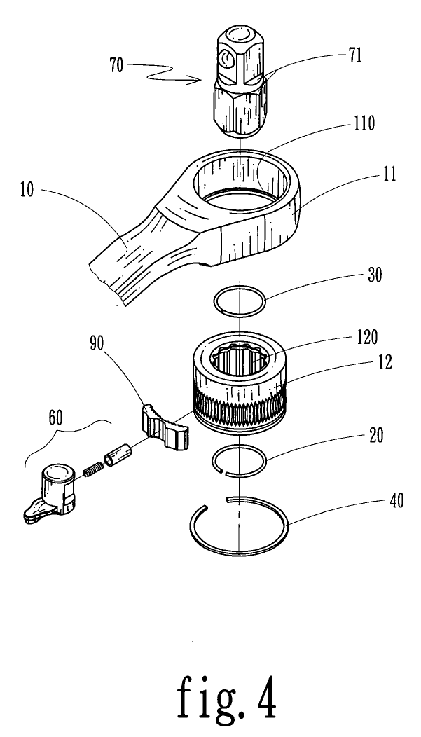

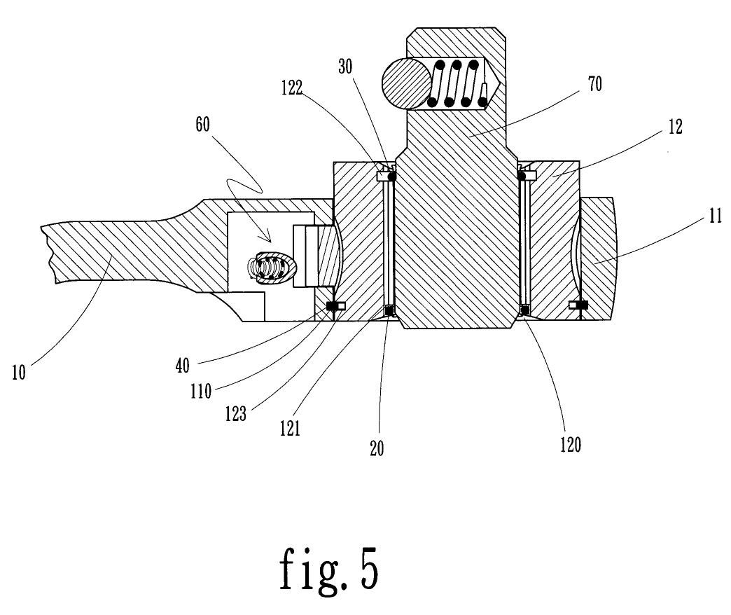

With reference to FIGS. 4 and 5, the ratchet wheel (12) is pivotally received in the enlarged head (11), and the C-shaped ring (40) is simultaneously received in the first annular groove (110) in the enlarged head (11) and the fourth annular groove (123) in the ratchet wheel (12) to hold the ratchet wheel (12) in place in the enlarged head (11).

A second tool bit (70) is partially inserted into the polygonal hole (120) in the ratchet wheel (12). The second tool bit (70) has a shoulder (71) formed on an outer periphery thereof. The retainer (30) clamps the shoulder (71) to position the second tool bit (70) and the top of the second tool bit (70) is engaged to the stopper (20) to prevent the second tool bit (70) from overly extending through the ratchet wheel (12) when the second tool bit (70) is partially into the polygonal hole (120) in the ratchet wheel (12).

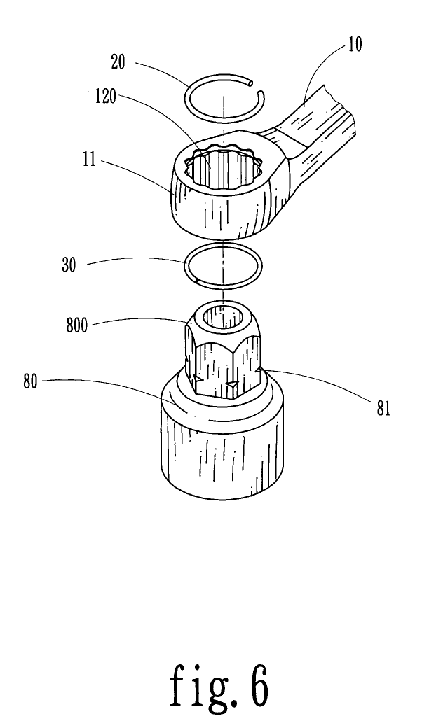

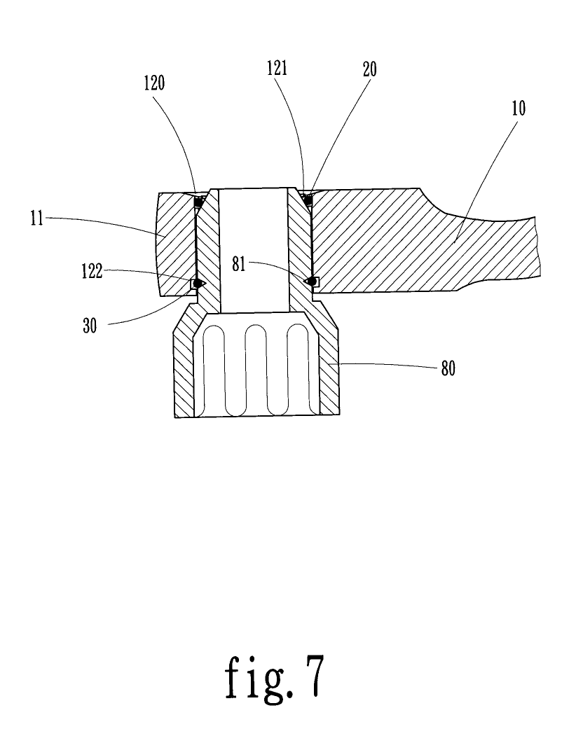

With reference to FIGS. 6 and 7, a third tool bit (80) is partially inserted into the polygonal hole (120) in the ratchet wheel (12). In the preferred embodiment of the present invention, the third tool bit (80) is a socket and has a shaft (800) centrally and longitudinally extending therefrom. An annular groove (81) is defined in an outer periphery of the shaft (800). The retainer (30) is simultaneously partially received in the annular groove (81) in the third tool bit (80) and the third annular groove (122) in the ratchet wheel (122) to position the third tool bit (80), an a top of the shaft (800) is engaged to the stopper (20) to prevent the shaft (800) overly extending through the ratchet wheel (12) when the third tool bit (80) is partially inserted into the polygonal hole (120) in the ratchet wheel (12).

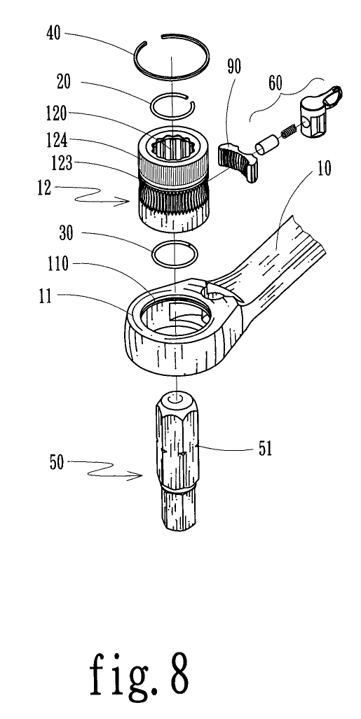

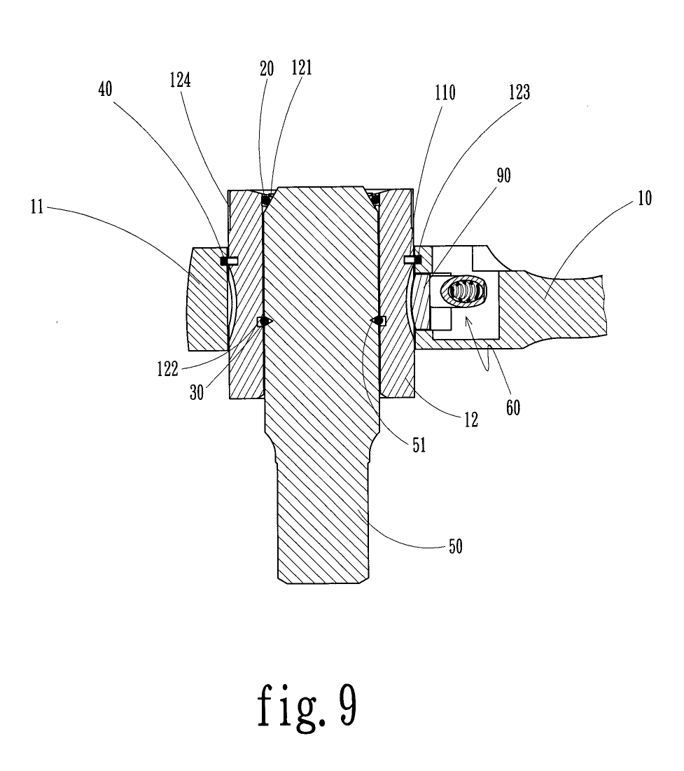

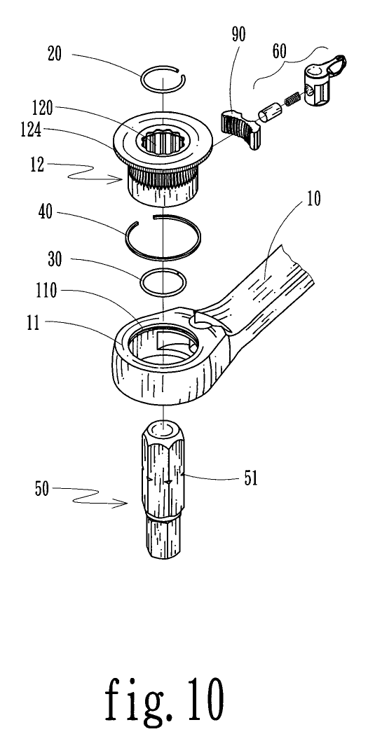

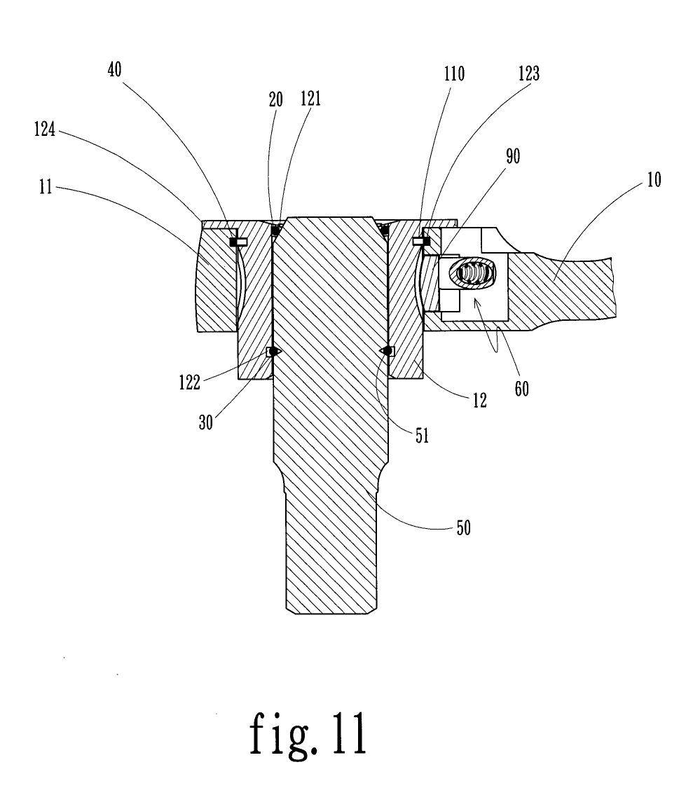

With reference to FIGS. 8-11, the ratchet wheel (12) is pivotally received in the enlarged head (11), and the C-shaped ring (40) is simultaneously received in the first annular groove (110) in the enlarged head (11) and the fourth annular groove (123) in the ratchet wheel (12) to hold the ratchet wheel (12) in place in the enlarged head (II). The ratchet wheel (12) further includes rotating structure (124) formed on the top thereof over the enlarged head (11). The operator can use the rotating structure (124) to quickly the ratchet wheel (12) with the tool bit for shortening the operating time. As shown in FIG. 8, the rotating structure (124) is cylindrical. As shown in FIG. 10, the rotating structure (124) is flat.

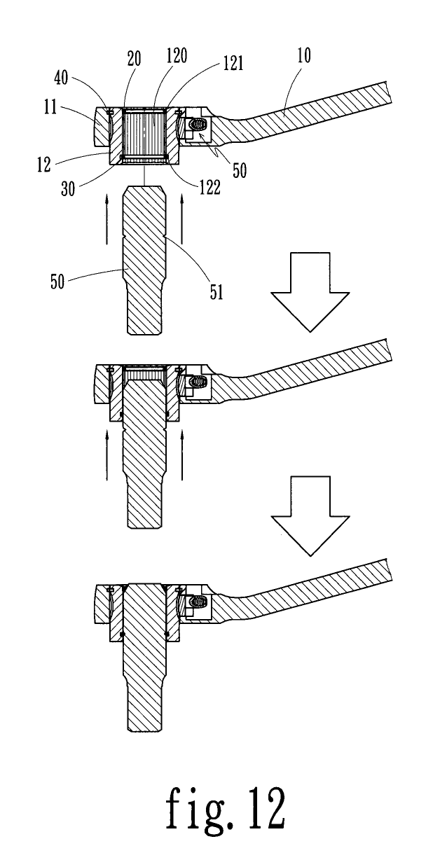

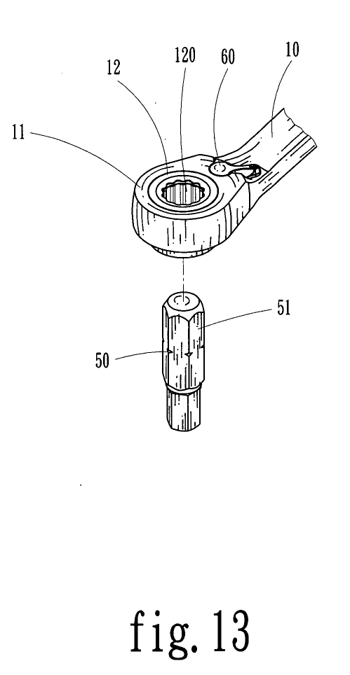

With reference to FIGS. 12 and 13, the retainer (30) is outwardly opened when the tool bit (50) inserted into the polygonal hole (120) in the ratchet wheel (12). The retainer (30) immediately shrinks to be partially received in the annular groove (51) to position the tool bit (50) when the annular groove (51) horizontally corresponds to the retainer (30). In addition, the top of the tool bit (50) abuts stopper (20) such that the tool bit (50) is stably positioned in the ratchet wheel (12).

Although the invention has been explained in relation to its preferred embodiment, it is to be understood that many other possible modifications and variations can be made without departing from the spirit and scope of the invention as hereinafter claimed.

1. A ratchet wrench with clamping and blocking functions, comprising:
a shank having an enlarged head formed on one end thereof, a through hole defined in the enlarged head and a ratchet wheel rotatably received in the through hole, a first annular groove defined in an inner periphery of the through hole, the ratchet wheel having a polygonal hole longitudinally defined therein, the polygonal hole extending through the ratchet wheel, a second annular groove and a third annular groove respectively defined in an inner periphery of the polygonal hole;
a tool bit releasably coupled to the polygonal hole of the ratchet wheel, the tool bit having an intermediate portion extending between upper and lower ends, the intermediate portion having at least one engagement surface formed therein to extend radially inward;
a stopper partially received in the second annular groove and adapted to prevent the tool bit from overly extending through the ratchet wheel; and
a retainer partially received in the third annular groove and engaging the engagement surface of the tool bit intermediate portion to position the tool bit in the ratchet wheel.

2. The ratchet wrench is claimed in claim 1, wherein the second annular groove is defined near a top of the ratchet wheel.

3. The ratchet wrench as claimed in claim 1, wherein the third annular groove is defined near a bottom of the ratchet wheel.

4. The ratchet wrench as claimed in claim 1, wherein the ratchet wheel has a fourth annular groove defined in an outer periphery thereof and laterally corresponding to the first annular groove when the ratchet wheel is received in the through hole in the enlarged head of the shank, a C-shaped ring received in the first annular groove and the fourth annular groove to hold the ratchet wheel in place in the enlarged head.

5. The ratchet wrench as claimed in claim 1, wherein a pawl is mounted in the enlarged head and selectively engaged to the ratchet wheel for setting the operating direction of the ratchet wheel.

6. The ratchet wrench as claimed in claim 5, wherein a direction control unit is mounted in the enlarged head for driving the pawl to engage to the ratchet wheel.
